(19) United States
(12) Patent Application Publication
(10) Pub. No.: US 2011/0320930 A1
(43) Pub. Date: Dec. 29, 2011

(54) METHOD AND MEANS FOR IDENTIFYING VALUABLE DOCUMENTS

(75) Inventors: Tiancai Liang, Guangdong (CN); Zongbin Mu, Guangdong (CN)

(73) Assignee: GRG Banking Equipment Co., Ltd., Guangzhou, Guangdong (CN)

(21) Appl. No.: 13/255,484

(22) PCT Filed: Mar. 9, 2010
(86) PCT No.: PCT/CN2010/070932

§ 371 Date: Sep. 8, 2011

(30) Foreign Application Priority Data
Mar. 10, 2009 (CN) 200910037735.0

(51) Int. Cl. G06F 17/00

(52) U.S. Cl. 715/234

(57) ABSTRACT

A method and means for identifying valuable documents is proposed. Wherein the method includes the following steps: collect multi-mode information of the valuable document to be identified, according to the pre-generated fusion strategy and the multi-mode information of the valuable document to be identified, identify the valuable document to be identified and obtain identification results. Through the embodiment of the present invention, identifying valuable documents based on the multi-mode information is implemented, and the identified reliability

This application claims the priority of Chinese Patent Application No. 200910037735.0, entitled “METHOD AND DEVICE FOR RECOGNIZING VALUABLE DOCUMENT”, filed with the Chinese Patent Office on Mar. 10, 2009, which is hereby incorporated by reference in its entirety.

### FIELD OF THE INVENTION

The present invention relates to the field of pattern recognition, and in particular to a method and device for recognizing a valuable document.

### BACKGROUND OF THE INVENTION

With the development of social economy, there is an increasing demand for anti-counterfeiting detection of a valuable document such as banknotes and valuable securities.

In the field of pattern recognition, taking a banknote as an example, the recognition of the valuable document is typically performing by recognizing the denomination of the banknote and determining whether the banknote is true or fake and whether the banknote is complete or worn and so on according to one type of modal information of the banknote (such as optical information or physical information).

In conceiving the present invention, the inventor finds out that the prior art has at least the following problems:

Single-modal information of the valuable document such as the banknote describes the banknote only on a certain level or in a certain aspect, which may not represent the characteristics of the banknote completely, and therefore it is incomplete. Moreover, the single-modal information of the banknote is easy to be interfered by external factors, for example, the single-modal information can be tampered and counterfeited easily; and thus it is uncertain and unstable.

### SUMMARY OF THE INVENTION

Embodiments of the present invention provide a method and device for recognizing a valuable document, so as to recognize the valuable document based on multimodal information and improve reliability and accuracy of the recognition.

In view of the above objects, an embodiment of the present invention provides a method for recognizing a valuable document, and the method includes the following steps:

collecting multimodal information of the valuable document to be recognized, wherein the multimodal information includes two or more of optical information, electrical information, magnetic information and physical information of the valuable document to be recognized; and

recognizing the valuable document to be recognized according to a pre-generated fusion strategy and the multimodal information of the valuable document to be recognized, and obtaining a recognition result.

In addition, an embodiment of the present invention also provides a device for recognizing a valuable document, and the device includes:

a collection module for collecting multimodal information of the valuable document to be recognized, wherein the multimodal information includes two or more of optical information, electrical information, magnetic information and physical information of the valuable document to be recognized; and

a recognition module for recognizing the valuable document to be recognized according to a pre-generated fusion strategy and the collected multimodal information of the valuable document to be recognized, and obtaining a recognition result.

The advantageous effects of the embodiments of the present invention are as follows:

According to the embodiments of the present invention, the recognition of a valuable document based on multimodal information is achieved by: collecting multimodal information of the valuable document to be recognized; and then recognizing the valuable document to be recognized according to a pre-generated fusion strategy and the multimodal information of the valuable document to be recognized and obtaining a recognition result. The multimodal information may represent the characteristics of the valuable document in the round, such as its authenticity, denomination and type, thus improving the reliability and accuracy of the recognition through the recognition method employing multimodal information.

### BRIEF DESCRIPTION OF THE DRAWINGS

In order to illustrate the technical solutions according to the embodiments of the present invention or in the prior art more clearly, drawings to be used in the description of the prior art or the embodiments will be described briefly hereinafter. Apparently, the drawings described hereinafter are only some embodiments of the present invention, and other drawings may be obtained by those skilled in the art according to those drawings without creative work.

FIG. 1 is a comparison diagram of spectrograms of a valuable document under irradiation of different wavelengths according to an embodiment of the present invention;

FIG. 2 is a reference diagram of position relationship between optical information and magnetic information of a valuable document provided by an embodiment of the present invention;

FIG. 3 is a schematic flow chart of the first embodiment of a method for recognizing a valuable document provided by an embodiment of the present invention;

FIG. 4 is a schematic flow chart of the second embodiment of a method for recognizing a valuable document provided by an embodiment of the present invention;

FIG. 5 is a schematic flow chart of the third embodiment of a method for recognizing a valuable document provided by an embodiment of the present invention;

FIG. 6 is a schematic flow chart of the fourth embodiment of a method for recognizing a valuable document provided by an embodiment of the present invention;

FIG. 7 is a schematic diagram of composition of the first embodiment of a device for recognizing a valuable document provided by an embodiment of the present invention;

FIG. 8 is a schematic diagram of composition of the second embodiment of a device for recognizing a valuable document provided by an embodiment of the present invention;

FIG. 9 is a schematic diagram of composition of the third embodiment of a device for recognizing a valuable document provided by an embodiment of the present invention; and

FIG. 10 is a schematic composition diagram of a first recognition unit in the third embodiment of the device for recognizing a valuable document provided by the embodiment of the present invention.

### DETAILED DESCRIPTION OF THE INVENTION

The technical solutions according to the embodiments of the present invention will be described clearly and completely hereinafter in conjunction with the drawings in the embodiments of the present invention. Apparently, the described embodiments are only a part of rather than all the embodiments of the present invention. All the other embodiments can be obtained by those skilled in the art based on the embodiments of the present invention without any creative work, which all fall within the scope of protection of the present invention.

The method and device for recognizing a valuable document provided by the embodiments of present invention includes: collecting multimodal information of a valuable document to be recognized; and recognizing the valuable document to be recognized according to a preset (i.e. pre-generated) fusion strategy and the multimodal information of the valuable document to be recognized, and obtaining a recognition result. By implementing the embodiments of present invention, the recognition of the valuable document based on multimodal information is achieved, and the reliability and accuracy of the recognition are improved.

In practice, information exists in various modes. Multimodal information of an objective thing refers to description information of the same objective thing obtained in different manners. Particularly, the multimodal information of a valuable document such as a banknote is able to represent the characteristics of the banknote in the round, such as its authenticity, state, type and denomination.

An embodiment of the present invention provides a technical solution for recognizing characteristics of a valuable document based on multimodal information, which includes: firstly collecting multimodal information of a valuable document to be recognized, wherein the multimodal information includes two or more of optical information, electrical information, magnetic information and physical information of the valuable document to be recognized; then generating a fusion strategy based on the multimodal information of the valuable document, according to the unique and determinate relationship between inherent characteristics of a standard valuable document, such as two or more of the optical information, the electrical information, the magnetic information, the physical information and so on of the standard valuable document; then processing the collected multimodal information of the valuable document to be recognized according to the fusion strategy; and finally obtaining a recognition result of the valuable document, for example accepting or rejecting the valuable document.

In order to facilitate the understanding of the technical solution of the embodiments according to the present invention, the method for providing the fusion strategy will be described in detail here.

The multimodal information of the standard valuable document is collected, wherein the multimodal information includes two or more of optical information, electrical information, magnetic information, physical information and so on of the valuable document. The unique and determinate relationship between the multimodal information can be obtained by integratively analyzing the multimodal information. Knowledge rule is formed by using these relationships, and the fusion strategy including one or more of a fusion strategy of collection level, a fusion strategy of quantization level, a fusion strategy of feature level and a fusion strategy of decision level is established under the instruction of the knowledge rule.

Referring to two examples of the fusion strategy of feature level and the fusion strategy of decision level, the technical solution will be further described hereinafter.

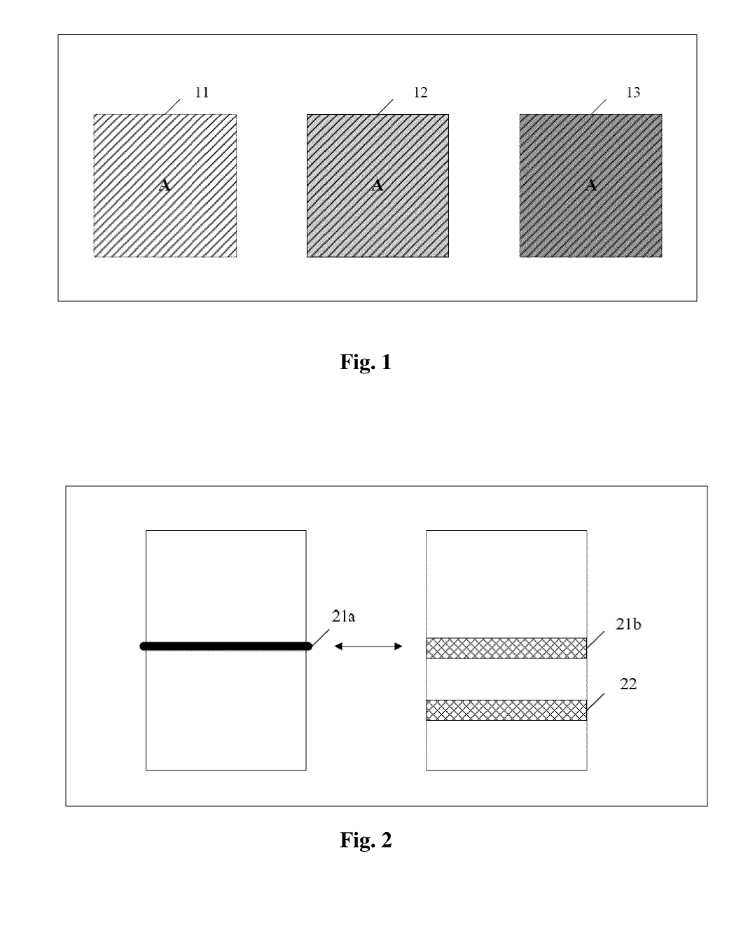

Reference to FIG. 1, a comparison diagram of spectrograms of a valuable document under irradiation of different wavelengths provided by an embodiment of the present invention is illustrated. For valuable documents made of the same physical material and in the same physical manner, there is a stable relationship between their imaging contents under irradiation of different wavelengths. As shown in FIG. 1, for a certain area A in a valuable document, the imaging contents under irradiation of three wavelengths λ₁, λ₂, λ₃ are respectively) ƒ(λ₁)11, ^{ƒ(λ}₂)12, ƒ(λ₃)13. It can be seen that there is constant differences in brightness between the three imaging contents, and the features extracted from these optical information will keep the relationships, so that the optical information under different wavelengths may be fused on the feature level.

Reference to FIG. 2, a reference diagram of position relationship between optical information and magnetic information of a valuable document provided by an embodiment of the present invention is illustrated. For a valuable document with magnetic safety line, such as a banknote, the magnetic safety line will be displayed obviously in the visible light information of the banknote. As shown in this figure, the image of the magnetic safety line of the banknote in the optical information (the visible light image) is a dark line, and the position 21a of the dark line is the imaging position of the magnetic safety line. When the magnetic information is collected, the imaging position 21a of the magnetic safety line may be taken as an auxiliary criterion for judging the validity of the magnetic information. Specifically, the magnetic information detected at the position 21a corresponding to the position of the dark line is valid, while the magnetic information detected at the position 22 not corresponding to the position of the dark line may be invalid. Conversely, the magnetic information may be taken as an auxiliary criterion for judging the validity of the imaging of the magnetic safety line, which will not be described in detail here. According to reference relationship between the imaging and the magnetic information of the magnetic safety line, it can be seen that the validity of the recognition of the valuable document utilizing the magnetic information may directly affect the validity of the recognition of the valuable document utilizing the optical information. Therefore, the magnetic information and the optical information may be fused on the decision level.

After the above fusion strategy is obtained, the valuable document to be recognized may be recognized based on the fusion strategy. It is to be noted that, when the similar or same valuable documents are recognized many times, the fusion strategy may be set only once and used many times. For example, when banknotes of 100-yuan RMB are recognized, the fusion strategy may be set before the first recognition, and then the set fusion strategy may be utilized many times to recognize 100-yuan RMB banknotes, without setting the fusion strategy before every recognition. In the following embodiments, the method for recognizing the valuable document to be recognized will be described in detail.

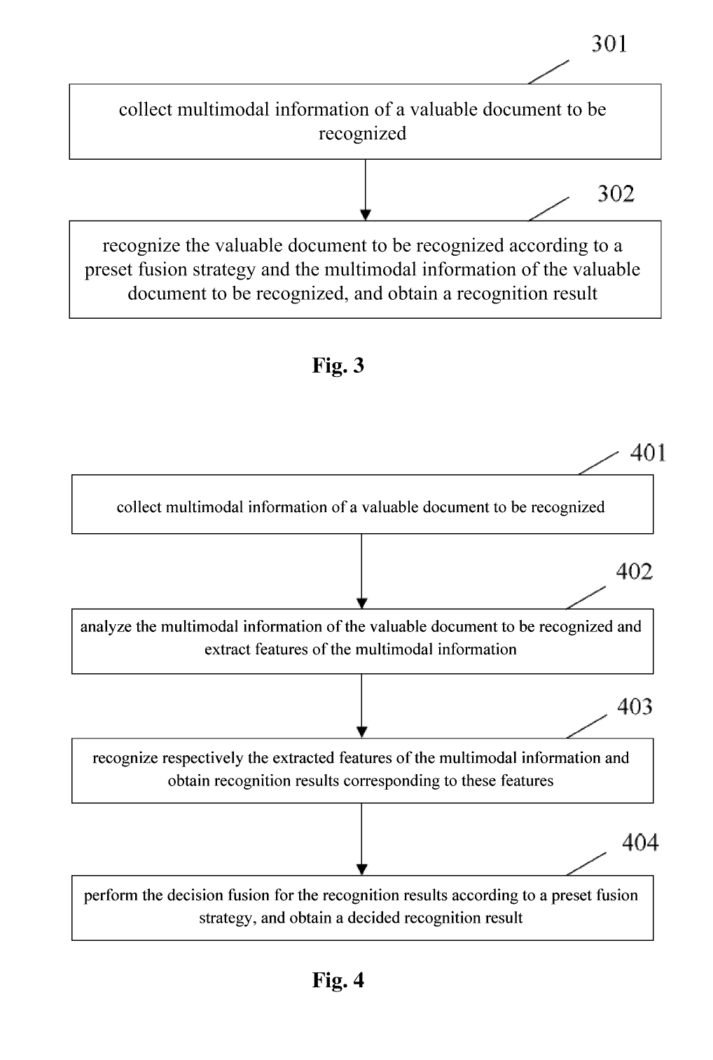

Reference to FIG. 3, a schematic flow chart of a first embodiment of a method for recognizing a valuable document provided by an embodiment of the present invention is shown. The method includes the following steps:

Step 301: collecting multimodal information of a valuable document to be recognized, wherein the multimodal information includes two or more of optical information, electrical information, magnetic information, physical information and so on of the valuable document to be recognized; and the valuable document may include a banknote, valuable securities, a ticket, a bill and so on. In this step, for example, the optical information is a spectral characteristic or the like; the electrical information is conductibility or the like; the physical information is information such as material, format and printed image. Practically, the mentioned information is not limited to those but may include other information, which is not limited by this embodiment; and

Step 302: recognizing the valuable document to be recognized according to a preset fusion strategy (i.e. a pre-generated fusion strategy, the same below) and the multimodal information of the valuable document to be recognized, and obtaining a recognition result.

Optionally, the method may further include: generating in advance a fusion strategy based on the multimodal information of the valuable document, according to the inherent characteristics of a standard valuable document.

According to this embodiment, the recognition of a valuable document based on multimodal information is achieved by collecting multimodal information of the valuable document to be recognized, and then recognizing the valuable document to be recognized according to a preset fusion strategy and the multimodal information of the valuable document to be recognized and obtaining a recognition result, thus improving the reliability and the accuracy of the recognition.

During the multimodal recognition of the valuable document to be recognized, the multimodal information may be fused on four levels, such as the collection level, the feature level, the quantization level and/or the decision level. In the following embodiments of the method according to the present invention, the fusion strategies of decision level, feature level and combination thereof are taken as examples to describe the method for recognizing the valuable document. However, the method is not limited to thereto.

Reference to FIG. 4, a schematic flow chart of a second embodiment of a method for recognizing a valuable document provided by an embodiment of the present invention is shown. The method includes the following steps:

Step 401: collecting multimodal information of a valuable document to be recognized, wherein the multimodal information includes two or more of optical information, electrical information, magnetic information, physical information and so on of the valuable document; and the valuable document may include a banknote, valuable securities, a ticket, a bill and so on;

Step 402: analyzing the multimodal information of the valuable document to be recognized and extracting features of the multimodal information, wherein the features of the multimodal information includes two or more of the feature of the optical information, the feature of the electrical information, the feature of the magnetic information, the feature of the physical information of the valuable document to be recognized. For example, by analyzing the multimodal information of the valuable document such as the banknote, the stable corresponding relationship between optical imaging position and the magnetic information of the magnetic safety line of the banknote may be obtained, and this corresponding relationship may be described by the textural characteristics of the optical image of the banknote, therefore the textural characteristics may be chosen as the features of the optical information;

Step 403: recognizing respectively each of the extracted features of the multimodal information and obtaining recognition results corresponding to these features. For example, a classifier is used to recognize the features, in which the feature of the magnetic information of the valuable document may be a first input feature of the classifier, and the feature of the physical information may be a second input feature of the classifier, and then the classification calculation can be performed for the above two input features respectively to obtain the classified recognition results; and

Step 404: performing a decision fusion for the recognition results according to a preset fusion strategy, and obtaining a decided recognition result, wherein the fusion strategy is the fusion strategy of the decision level, such as the AND method, i.e. when all the classification results satisfy the conditions for the decision fusion, for example, when the optical information, the magnetic information and the physical information of the banknote are all correct, the banknote can be accepted.

According to this embodiment, the decision fusion is performed for the recognition results corresponding to the features of the multimodal information, and the recognition result is the conclusion obtained by synthesizing the recognized results of many features. Therefore, the reliability and accuracy of the recognition of the valuable document can be improved by the decision fusion.

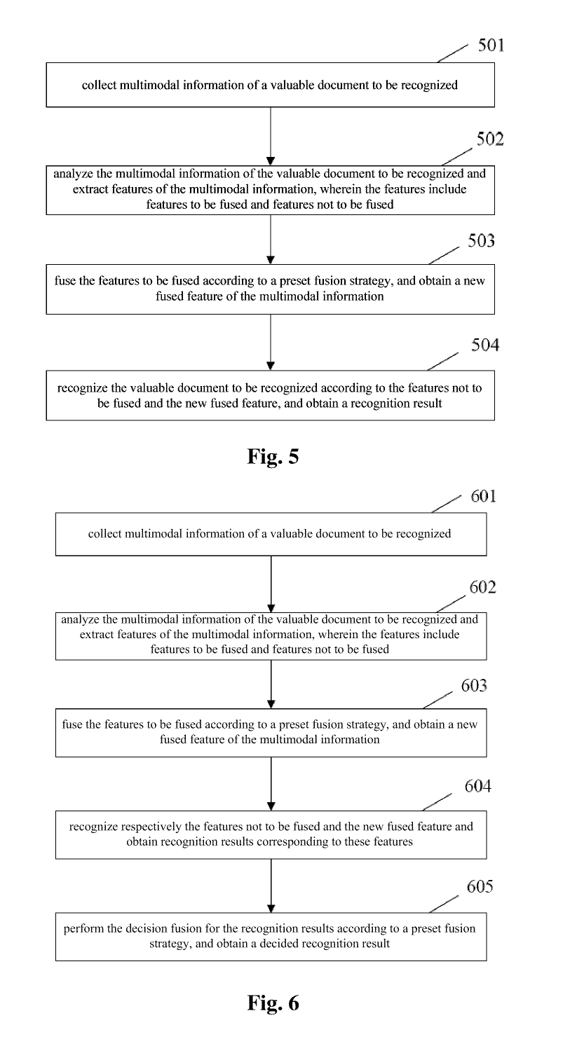

Reference to FIG. 5, a schematic flow chart of a third embodiment of a method for recognizing a valuable document provided by an embodiment of the present invention is shown. The method includes the following steps:

Step 501: collecting multimodal information of a valuable document to be recognized;

Step 502: analyzing the multimodal information of the valuable document to be recognized and extracting features of the multimodal information, wherein the features include features to be fused and features not to be fused, wherein the features to be fused are the features which will be fused and the number of these features is at least two; and the features not to be fused refer to the features which are not to be fused and the number of these features is not limited and of course may be zero;

Step 503: fusing the features to be fused according to a preset fusion strategy, and obtaining a new fused feature of the multimodal information. For example, the optical information under irradiation of different wavelengths, such as red light, infrared light and ultraviolet light, are fused to obtain a new feature which contains three types of optical information of the valuable document to be recognized. It is to be noted that the fusion strategy in this step is the fusion strategy of feature level, such as the weighted average method; and

Step 504: recognizing the valuable document to be recognized according to the features not to be fused and the new fused feature, and obtaining a recognition result. It is to be noted that, when the number of the features not to be fused is zero, the valuable document to be recognized may be recognized according to the new fused feature only to obtain the recognition result.

According to this embodiment, the features of the multimodal information of the valuable document are fused to obtain a new fused feature which may represent the characteristics of the valuable document more accurately and completely.

Reference to FIG. 6, a schematic flow chart of the fourth embodiment of a method for recognizing a valuable document provided by an embodiment of the present invention is shown. Steps 601 to 603 in this method are the same as the steps 501 to 503 in the third embodiment of the method for recognizing the valuable document, which will not be described in detail any more. Moreover, the step 504 in the third embodiment specifically is corresponding to step 604 and step 605 in this embodiment:

Step 604: recognizing respectively the features not to be fused and the new fused feature and obtaining recognition results corresponding to these features. For example, the new fused feature is a new feature of the optical information formed by fusing the red light, the infrared light and the ultraviolet light; and the features not to be fused include the features of the magnetic and physical information of the valuable document. The new feature of the optical information of the valuable document may be set as a first input feature of a classifier, the feature of the magnetic information of the valuable document may be set as a second input feature of the classifier, and the feature of the physical information may be set as a third input feature of the classifier, and then the classification calculation is performed for the above three input features respectively to obtain the classified results; and

Step 605: performing the decision fusion for the recognition results according to a preset fusion strategy, and obtaining a decided recognition result.

According to this embodiment, the features of the multimodal information of the valuable document are fused and the decision fusion is performed for the recognition results of the features to obtain a decided recognition result. After two levels of fusion, the reliability and accuracy of the recognition of the valuable document are improved.

In order to facilitate the understanding of the technical solution of the embodiments according to the present invention, the specific implementation of the embodiments according to the present invention will be described in detail hereinafter, by taking the banknote in the valuable document as an example.

Step 1: collecting the multimodal information of the banknote by a sensor, and in this example, the following information are chosen as the modal information of the banknote:

1. red light information of the banknote;

2. infrared light information of the banknote;

3. ultraviolet light information of the banknote;

4. magnetic information of the banknote; and

5. physical information (thickness, format etc.) of the banknote.

Step 2: analyzing the relationship between the multimode information; forming knowledge rules; and storing the knowledge rules into a memory. According to the knowledge rules formed in this step, the fusion strategy may be established and the features of the multimodal information may be extracted.

For the printed documents made of the same physical material in the same physical manner, there is a stable relationship between the imaging contents under irradiation of different wavelengths. Accordingly, the feature level fusion strategy is established, which is referred to as a first fusion rule herein: the optical information of different wavelengths may be fused on the feature level and the fusion strategy of the weighted average method is employed.

Because of the uniformity among the optical, magnetic and physical information of the banknote, during the recognition, it may be rejected to recognize the banknote once one of the above information fails to meet the requirement. Accordingly, the fusion strategy of decision level is established, which is referred to as a second fusion rule here: the magnetic and physical information nay be fused on the decision level and the fusion strategy of AND is employed.

Because there exists a stable corresponding relationship between the optical imaging position and the magnetic information of the magnetic safety line of the banknote, and these corresponding relationships may be represented by the textural characteristics of the optical image of the banknote, and thus the textural characteristics are chosen as the features of the optical information in this embodiment.

Step 3: extracting the features of the multimodal information of the banknote, wherein these features are the textural characteristics of the optical image of the banknote.

1. The feature X₁={x₁₁, x₁₂, • • •, x₁ₙ} is extracted from the red light information of the banknote;

2. the feature X₂={x₂₁, x₂₂, • • •, x₂ₙ} is extracted from the infrared light information of the banknote;

3. the feature X₃={x₃₁, x₃₂, • • •, x₃ₙ} is extracted from the ultraviolet light information of the banknote;

4. the feature X₄={x₄₁, x₄₂, • • •, x₄ₙ} is extracted from the magnetic information of the banknote; and

5. the feature X₅={x₅₁, x₅₂, • • •, x₅ₙ} is extracted from the physical information of the banknote.

Where the symbol Xₖ(k=1,2,3,4,5) represents a characteristic vector and the symbol xₖᵢ(i=1,2, • • •, n) represents a characteristic component in the characteristic vector.

Step 4: fusing the features.

According to the fusion rule 1, the features X₁, X₂, X₃ of the optical information of the banknote are fused according to the weighted average method. The computation formula for the weighted average method is as follows:

x′ᵢ=ƒ(x₁ᵢ, x₂ᵢ, • • •, xₘᵢ)=W₁x₁ᵢ+W₂x₂ᵢ+ • • • +Wₘxₘᵢ (1)

where x′ᵢ is the characteristic component of the new fused feature X′; xₖᵢ is the characteristic component of the feature Xₖ, and xₖᵢ ∈ Xₖ; Wₖ is the weight factor, Wₖ>0 and

$${\sum }_{k = 1}^{m} {W}_{k} = 1.$$

X₁, X₂ and X₃ are fused according to the formula (1), where m=3, then X′={x′₁, x′₂, • • •, x′ₙ}.

The advantageous effects of this step are as follows: the features of the three light information (red light, infrared light, ultraviolet light) are fused to obtain a new feature X′ which contains all the three types of light information of the banknote and may represent the banknote more accurately and completely.

Step 5: classifying the features.

1. Classifier

(1) Descriptions of the Classifier

Provided that D={D₁,D₂,D₃} represents a group of classifiers, where Dᵢ(i=1,2,3) represents a component classifier.

In this embodiment, the Bayesian network is chosen as the classifier D₁, the three-layer BP network, namely the three-layer feed-forward network, is chosen as the classifier D₂ and the decision tree is chosen as the classifier D₃.

(2) input

The characteristic vector X ∈ [symbol] is input; and different component classifiers correspond to different input characteristic vectors.

The input of the classifier D₁ is the fused feature X′ of the optical information;

the input of the classifier D₂ is the feature X₄ of the magnetic information; and

the input of the classifier D₃ is the feature X₅ of the physical information.

(3) Descriptions of Classes

Provided that Θ={ω₁, ω₂, • • •, ω_{L}} represents a group of class marks, ωᵢ represents the i-th class.

(4) Output

The output of the component classifier is a vector having a length of L: Dᵢ(X)=[dᵢ₁(X),dᵢ₂(X), • • •, d_{iL}(X)]^{T},

where dᵢⱼ(X) represents the support degree of Dᵢ to X belonging to ωᵢ, and

$${\sum }_{j = 1}^{L} {d}_{ij} ( X ) = 1.$$

The output of the classified D₁ is D₁(X′)−[d₁₁(X′), d₁₂(X′), • • •, d_{1L}(X′)]^{T};

the output of the classifier D₂ is D₂(X₄)=[d₂₁(X₄, d₂₂(X₄), • • •, d_{2L}(X₄)]^{T}; and

the output of the classified D₃ is D₃(X₅)=[d₃₁(X₅), d₃₂(X₅), • • •, d_{3L}(X₅)]^{T}.

The classification result of each component classifier is that

Oᵢ=max{d_{y}(X)|X ∈ [symbol] ″} (2)

where Oᵢ represents class, i=1,2,3, j=1,2, • • •, L.

2. Training

A group of banknotes are chosen as training samples. Provided that a sample set with N samples is Ω={B₁,B₂, • • •, B_{N}}, where Bₖ(k=1,2, • • •, N) represents the k-th sample.

The class mark is assigned to the sample Bₖ(k1,2, • • •, N) in the training sample set Ω. Provided that the mark of Bₖ is ωₜ, then the outputs of the component classifiers meet the following constraint conditions:

(1) for the classified D₁:

$${O}_{1} ( {B}_{k} ) = {ω}_{t} ⇔ {d}_{1 t} ( {X}^{′} ) = {max}_{j = 1 , 2 , … , L} \{ {d}_{1 j} ( X ) \} ;$$

(2) for the classifier D₂:

$${O}_{2} ( {B}_{k} ) = {ω}_{t} ⇔ {d}_{2 t} ( {X}_{4} ) = {max}_{j = 1 , 2 , … , L} \{ {d}_{2 j} ( {X}_{4} ) \} ;$$

and

(3) for the classified D₃:

$${O}_{3} ( {B}_{k} ) = {ω}_{t} ⇔ {d}_{3 t} ( {X}_{5} ) = {max}_{j = 1 , 2 , … , L} \{ {d}_{3 j} ( {X}_{5} ) \} .$$

Each component classifier Dᵢ(i=1,2,3) is trained by the training samples set until the outputs of each component classifier meet the above three constraint conditions for any sample Bₖ.

3. Classification

The features of multimodal information of the target, namely the banknote to be recognized, are computed by the trained classifier to obtain a group of classification output results O₁, O₂, O₃.

The advantageous effects of this step are as follows: one implementation of each component classifier may be obtained by training the classifier; the features of the multimodal information of the target banknote are computed utilizing the component classifiers obtained by training to obtain a group of candidate classification results O₁, O₂, O₃ which may be used for the decision fusion.

Step 6: performing the decision fusion.

According to the fusion rule 2, the decision fusion is performed by utilizing the AND method, and the computation formula of the decision fusion is as follows:

$$O ( B ) = \{ \begin{matrix}{ω}_{t} ( t = 1 , 2 , … , L ) & when {O}_{1} ( B ) = {O}_{2} ( B ) = {O}_{3} ( B ) = {ω}_{t} \\ rejected & otherwise\end{matrix} \qquad ( 3 )$$

where B represents the target to be recognized, such as the banknote, Oᵢ(B)(i=1,2,3) represents the classification results of the component classifiers, and ω₁ represents the class.

The decision fusion is performed for the results obtained by classifying by the classifier according to the formula (3) to get the final recognition result. That is to say, the target banknote will be accepted if the classification result O₁ of the features of the optical information, the classification result O₂ of the features of the magnetic information, and the classification result O₃ of the features of the physical information all meet the conditions in the formula of the decision fusion, and the target banknote will be rejected if one of the conditions is not satisfied.

According to this step, the decision fusion is performed for a group of the candidate classification results, so as to improve the reliability and accuracy of the final recognition result.

According to this embodiment, the recognition of the banknote is achieved utilizing the multimodal information of the banknote via two levels of fusion. During the recognition, types of multimodal information of the banknote are synthesized, and the multimodal information may represent the characteristics of the valuable document more accurately and completely, so as to improve the reliability and accuracy of the recognition of the banknote.

Taking the banknote as an example, the counterfeit banknote recognition using the fusion technique of the multimodal information described above is only a simple example. The fusion of the multimodal information may also be divided into three levels: source data level fusion, feature level fusion, and decision level fusion.

Among the three levels, the source data level fusion is aimless and is not recommended to fusing the information in principle.

In the aspect of the feature level fusion according to the present invention, besides the weighted average method in the embodiment, the following fusion rules may be employed as required; and in the aspect of the decision level fusion, besides the AND method in the embodiment, the following fusion rules may also be employed as required.

The feature level fusion may be divided into two types as follows:

(1) Target State Information Fusion

For date parameters correlation and state estimation, the target state information fusion mainly includes information fusion rules such as the sequential estimation method and Kalman filtering method.

(2) Target Characteristic Fusion

For the combinations of feature vectors, the target characteristic fusion mainly includes fusion rules such as the clustering, the neural network, the weighted average method, the maximum value method, the minimum value method and the average summation method.

In the aspect of the decision level fusion:

For the joint decision problems, the decision level fusion mainly includes fusion rules such as the logic combination of “AND” and “OR”, Bayes theory, D-S evidence theory, the production rules, the fuzzy set theory, the rough set theory and the expert system.

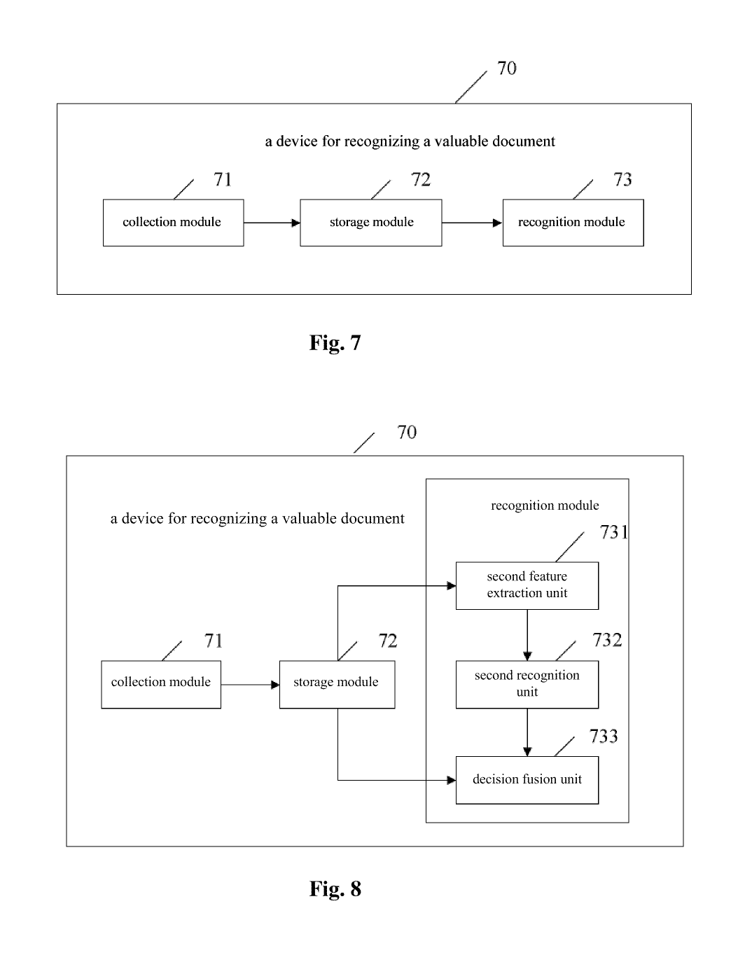

Reference to FIG. 7, a schematic composition diagram of a first embodiment of a device for recognizing a valuable document provided by an embodiment of the present invention is shown. As shown in the figure, a device 70 for recognizing a valuable document includes:

a collection module 71 for collecting multimodal information of a valuable document to be recognized, wherein the multimodal information includes two or more of optical information, electrical information, magnetic information, physical information and so on of the valuable document to be recognized; and the valuable document may include a banknote, valuable securities, a ticket, a bill and so on;

a storage module 72 for storing a preset fusion strategy and the multimodal information collected by the collection module 71; wherein the preset fusion strategy is a fusion strategy based on the multimodal information of the valuable document which is generated according to inherent characteristics of a standard valuable document; and

a recognition module 73 for recognizing the valuable document to be recognized according to the fusion strategy stored by the storage module 72 and the multimodal information of the valuable document to be recognized, and obtaining a recognition result.

According to this embodiment, the recognition of a valuable document based on multimodal information is achieved by collecting multimodal information of the valuable document to be recognized; and recognizing the valuable document to be recognized according to a preset fusion strategy and the multimodal information of the valuable document to be recognized, and obtaining a recognition result, thus improving the reliability and accuracy of the recognition.

Reference to FIG. 8, a schematic composition diagram of a second embodiment of a device for recognizing a valuable document provided by an embodiment of the present invention is shown. As shown in the figure, compared with the first embodiment of the device for recognizing a valuable document, the device in this embodiment has the same collection module 71 and the same storage module 72, while the recognition module 73 includes:

a second feature extraction unit 731 for analyzing multimodal information of the valuable document to be recognized which is stored by the storage module 72 and extracting the features of the multimodal information;

a second recognition unit 732 for recognizing respectively the features of the multimodal information extracted by the second feature extraction unit 731 and obtaining recognition results corresponding to these features; and

a decision fusion unit 733 for performing a the decision fusion for the recognition results obtained by the second recognition unit 732 according to a fusion strategy of decision level in the fusion strategy stored by the storage module 72, and obtaining a decided recognition result, in which the fusion strategy is a fusion strategy on the decision level.

It is to be noted that the functions performed by the above units of the recognition module 73 refer to the corresponding description of the second embodiment of the method for recognizing the valuable document.

According to this embodiment, the decision fusion is performed for the recognition results corresponding to the features of the multimodal information. The recognition result is the conclusion obtained by synthesizing the recognized results of many features. Therefore, the reliability and the accuracy of the recognition of the valuable document are improved by the decision fusion.

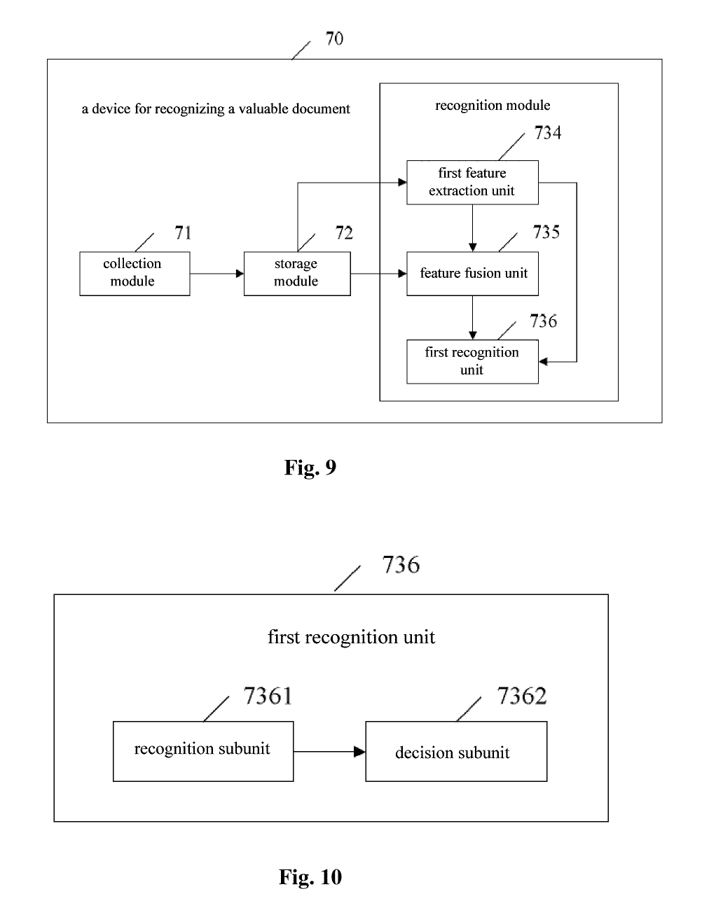

Reference to FIG. 9, a schematic composition diagram of a third embodiment of a device for recognizing a valuable document provided by an embodiment of the present invention is shown. As shown in the figure, compared with the first embodiment of the device for recognizing a valuable document, the device for recognizing in this embodiment has the same collection module and the same storage module, while the recognition module 73 includes:

a first feature extraction unit 734 for analyzing multimodal information of the valuable document to be recognized which is stored by the storage module 72, and extracting features of the multimodal information, wherein the features include features to be fused and features not to be fused;

a feature fusion unit 735 for fusing the features to be fused which are extracted by the first feature extraction unit 734 according to a fusion strategy of feature level in the fusion strategies stored by the storage module 72, and obtaining a new fused feature of the multimodal information; and

a first recognition unit 736 for recognizing the valuable document to be recognized according to the features not to be fused which are extracted by the first feature extraction unit 734 and the new fused feature obtained by the feature fusion unit 735, and obtaining a recognition result.

It is to be noted that the functions performed by each above units of the recognition module 73 refer to the corresponding description of the third embodiment of the method for recognizing the valuable document.

According to this embodiment, the new fused feature is obtained by fusing the features of the multimodal information of the valuable document. The new feature contains types of modal information of the valuable document and may represent the characteristics of the valuable document more accurately and completely.

Reference to FIG. 10, a schematic composition diagram of a first recognition unit of the third embodiment of the device for recognizing a valuable document provided by a third embodiment of the present invention is shown; and reference to FIG. 9 together, in this embodiment, the first recognition unit 736 includes:

a recognition subunit 7361 for recognizing respectively the features not to be fused which are extracted by the first feature extraction unit 734 and the new fused feature obtained by the feature fusion unit 735, and obtaining recognition results corresponding to these features; and

a decision subunit 7362 for performing the decision fusion for the recognition results obtained by the recognition subunit 7361 according to a fusion strategy of decision level in the fusion strategy stored by the storage module 72, and obtaining a decided recognition result.

It is to be noted that, the functions performed by each above subunits of the first recognition unit 736 refer to the corresponding description of the fourth embodiment of the method for recognizing the valuable document.

Moreover, the device for recognizing the valuable document in an embodiment according to the present invention may include only a collection module and a recognition module, in which the collection module is adapted to collect multimodal information of a valuable document to be recognized, and the multimodal information includes two or more of the optical information, the electrical information, the magnetic information and the physical information of the valuable document to be recognized; and the recognition module is adapted to recognize the valuable document to be recognized according to a pre-generated fusion strategy and the collected multimodal information of the valuable document to be recognized, and obtain a recognition result.

Optionally, the device may further include a pre-generation module for generating in advance, a fusion strategy based on the multimodal information of the valuable document, according to the inherent characteristics of a standard valuable document, wherein the fusion strategy generated by the pre-generation module is a pre-generated fusion strategy.

Optionally, the device may further include a storage module for storing the pre-generated fusion strategy, and the multimodal information collected by the collection module.

In this embodiment, the recognition module may include a first feature extraction unit, a feature fusion unit and a first recognition unit; and the first recognition unit may include a recognition subunit and a decision subunit; the recognition module may include a second feature extraction unit, a second recognition unit and a decision fusion unit, wherein the descriptions of the functions of each units or subunits are as above and will not be described in detail any more.

According to this embodiment, the features of the multimodal information of the valuable document are fused, the recognition results of the features are fused on decision level to obtain a decided recognition result. After two levels of fusion, the reliability and the accuracy of the recognition of the valuable document are improved.

In other embodiments according to the present invention, a product related to the recognition of a valuable document includes a part of or all of the units in the recognition device in the embodiments according to the present invention. For example, a control sensor can be the collection module 71 in the embodiments of the present invention; a memory can be the storage module 72 in the embodiments of the present invention; a processor can be the recognition module 73 in the embodiments of the present invention. Further, the processor also includes a second feature extraction unit 731, a second recognition unit 732, a decision fusion unit 733, a first feature extraction unit 734, a feature fusion unit 735, a first recognition unit 736, a recognition subunit 7361 and a decision subunit 7362.

It is to be noted that, except the single level fusion and the two level fusion based on the feature level and the decision level described above in embodiments, in other embodiments according to the present invention, the multimodal information can be fused on the collection level and/or the multimodal information of a valuable documents can be fused on the quantization level. In a word, the multimodal information of a valuable document may be fused on a group of levels selected from the four levels, i.e. the collection level, the quantization level, the feature level and the decision level. Further, the quantization level fusion includes two steps: normalizing and fusing; the fusion strategy of feature level is not limited to the weighted average method mentioned in the above embodiments and may further include the average summation method, the maximum value method and the minimum value method etc; the fusion strategy of decision level is also not limited to the AND method mentioned in the above embodiments, which is mainly divided into two kinds: one is a method in which parameters are not to be trained, such as the voting method, the AND method and the OR method, and the other is a method in which parameters are to be trained, such as the D-S evidence theory, Bayes estimation method, fuzzy clustering method.

All those disclosed above are only preferred embodiments according to the present invention and can certainly not be used to define the scope of protection of the claims of the present invention. Accordingly, the equivalent alternation made based on the present invention still falls within the scope of protection of the present invention.

1. A method for recognizing a valuable document, comprising:
collecting multimodal information of a valuable document to be recognized, wherein the multimodal information comprises two or more of optical information, electrical information, magnetic information and physical information of the valuable document to be recognized; and
recognizing the valuable document to be recognized according to a pre-generated fusion strategy and the collected multimodal information of the valuable document to be recognized, and obtaining a recognition result.

2. The method for recognizing the valuable document according to claim 1, wherein the method further comprises:
pre-generating a fusion strategy based on the multimodal information of the valuable document, according to inherent characteristics of a standard valuable document.

3. The method for recognizing the valuable document according to claim 1, wherein the step of recognizing the valuable document to be recognized according to the pre-generated fusion strategy and the collected multimodal information, and obtaining a recognition result comprises:
analyzing the multimodal information of the valuable document to be recognized and extracting a features of the multimodal information, wherein the feature comprise a feature to be fused and a feature not to be fused;
fusing the features to be fused according to a fusion strategy of feature level in the fusion strategy, and obtaining a new fused feature of the multimodal information; and
recognizing the valuable document to be recognized according to the features not to be fused and the new fused feature, and obtaining a recognition result.

4. The method for recognizing the valuable document according to claim 3, wherein the step of recognizing the valuable document to be recognized according to the features not to be fused and the new fused feature, and obtaining a recognition result comprises:
recognizing respectively the features not to be fused and the new fused feature and obtaining recognition results corresponding to these features; and
performing a decision fusion for the recognition results according to a fusion strategy of decision level in the fusion strategy, and obtaining a decided recognition result.

5. The method for recognizing the valuable document according to claim 1, wherein the step of recognizing the valuable document to be recognized according to a pre-generated fusion strategy and the multimodal information of the valuable document to be recognized and obtaining a recognition result comprises:
analyzing the multimodal information of the valuable document to be recognized and extracting features of the multimodal information;
recognizing respectively the extracted features of the multimodal information and obtaining recognition results corresponding to these features; and
performing a decision fusion for the recognition results according to a fusion strategy of decision level in the fusion strategy, and obtaining a decided recognition result.

6. The method for recognizing the valuable document according to claim 1, wherein the valuable document comprises a banknote, valuable securities, a ticket or a bill.

7. A device for recognizing a valuable document, comprising:
a collection module for collecting multimodal information of a valuable document to be recognized, wherein the multimodal information comprises two or more of optical information, electrical information, magnetic information and physical information of the valuable document to be recognized; and
a recognition module for recognizing the valuable document to be recognized according to a pre-generated fusion strategy and the collected multimodal information of the valuable document to be recognized, and obtaining a recognition result.

8. The device for recognizing the valuable document according to claim 7, wherein the device further comprises:
a pre-generation module for pre-generating a fusion strategy based on the multimodal information of the valuable document according to inherent characteristics of a standard valuable document.

9. The device for recognizing the valuable document according to claim 7, wherein the device further comprises:
a storage module for storing the pre-generated fusion strategy, and the multimodal information collected by the collection module.

10. The device for recognizing the valuable document according to claim 9, wherein the recognition module comprises:
a first feature extraction unit for analyzing the multimodal information of the valuable document to be recognized which is stored by the storage module and extracting features of the multimodal information, wherein the features comprise features to be fused and features not to be fused;
a feature fusion unit for fusing the features to be fused which are extracted by the first feature extraction unit according to a fusion strategy of feature level in the fusion strategy stored by the storage module, and obtaining a new fused feature of the multimodal information; and
a first recognition unit for recognizing the valuable document to be recognized according to the features not to be fused which are extracted by the first feature extraction unit and the new fused feature obtained by the feature fusion unit, and obtaining a recognition result.

11. The device for recognizing the valuable document according to claim 10, wherein the first recognition unit comprises:
a recognition subunit for recognizing respectively the features not to be fused which are extracted by the first feature extraction unit and the new fused feature obtained by the feature fusion unit and obtaining recognition results corresponding to these features; and
a decision subunit for performing the decision fusing for the recognition results obtained by the recognition subunit according to a fusion strategy of decision level in the fusion strategy stored by the storage module, and obtaining a decided recognition result.

12. The device for recognizing the valuable document according to claim 9, wherein the recognition module comprises:
a second feature extraction unit for analyzing the multimodal information of the valuable document to be recognized which is stored by the storage module and extracting features of the multimodal information;
a second recognition unit for recognizing respectively the features of the multimodal information extracted by the second feature extraction unit and obtaining recognition results corresponding to these features; and
a decision fusion unit for performing the decision fusing for the recognition results obtained by the second recognition unit according to a fusion strategy of decision level in the fusion strategy stored by the storage module, and obtaining a decided recognition result.

13. The device for recognizing the valuable document according to claim 8, wherein the device further comprises:
a storage module for storing the pre-generated fusion strategy, and the multimodal information collected by the collection module.
